(19) United States
(12) Patent Application Publication
(10) Pub. No.: US 2005/0109150 A1
(43) Pub. Date: May 26, 2005

(54) Bicycle handlebar assembly

(76) Inventors: Douglas Chiang, Dali City (TW); David Michael Anthony, Dali City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/722,224

(22) Filed: Nov. 25, 2003

(51) Int. Cl. B62K 21/12

(52) U.S. Cl. 74/551.1

(57) ABSTRACT

A bicycle handlebar includes a straight central fitting section and two wings are integrally connected to two ends of the central fitting section. Each wing has a tear-shaped cross section including a long axis and a short axis which orthogonally intersects the long axis at an intersection point. A distance from the intersection point to a front end of each of the tear-shaped wings is longer than a distance from the intersection point to a rear end of each of the tear-shaped wings.

### FIELD OF THE INVENTION

The present invention relates to a bicycle handlebar assembly having two wings each include a linear profile so as to reduce air resistance.

### BACKGROUND OF THE INVENTION

A conventional bicycle handlebar assembly 1 is shown in FIG. 6 and generally includes a handlebar composed of a central fitting section 2 and two wings 3 integrally connected to two ends of the central fitting section 2. Tow grips (not shown) are connected to two wings 3 so that the rider can hold the grips while riding the bicycle. Two connection members 5 are fixed to the central fitting section 2 and each connection member 5 has a tube so that two armrests 6 are inserted in the two tubes. An elbow pad 60 is connected to the two armrests 6 and located close to the central fitting section 2. The armrests 6 allow the rider to rest his or her arms during taxing and the elbows are rested on the elbow pads 60. Nevertheless, the two wings 3 are made to have a rectangular profile and include a front rectangular area 30 facing the wind when riding the bicycle. The front rectangular area 30 causes a certain resistance by the wind and this may be critical factor for a racing bicycle.

The present invention intends to provide a linear bicycle handlebar which includes two wings having a tear-shaped cross section so as to reduce resistance when riding.

### SUMMARY OF THE INVENTION

The present invention relates to a bicycle handlebar assembly comprising a central fitting section and two wings are integrally connected to two ends of the central fitting section. Each wing has a tear-shaped cross section including a long axis and a short axis which orthogonally intersects the long axis at an intersection point. A distance from the intersection point to a front end of each of the tear-shaped wings is longer than a distance from the intersection point to a rear end of each of the tear-shaped wings.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the handlebar assembly of the present invention;

FIG. 2 shows the central fitting section of the handlebar assembly has a circular cross section;

FIG. 3 shows each of the wings of the handlebar assembly has a tear-shaped cross section;

FIG. 4 is an exploded view to show the handlebar, a handlebar stem and two armrests;

FIG. 5 is a perspective view to show the handlebar assembly connected to a bicycle frame by the handlebar stem, and

FIG. 6 shows a conventional handlebar assembly.

### DETAILED DESCRIPTION OF THE PREFERRED EMBODIMENT

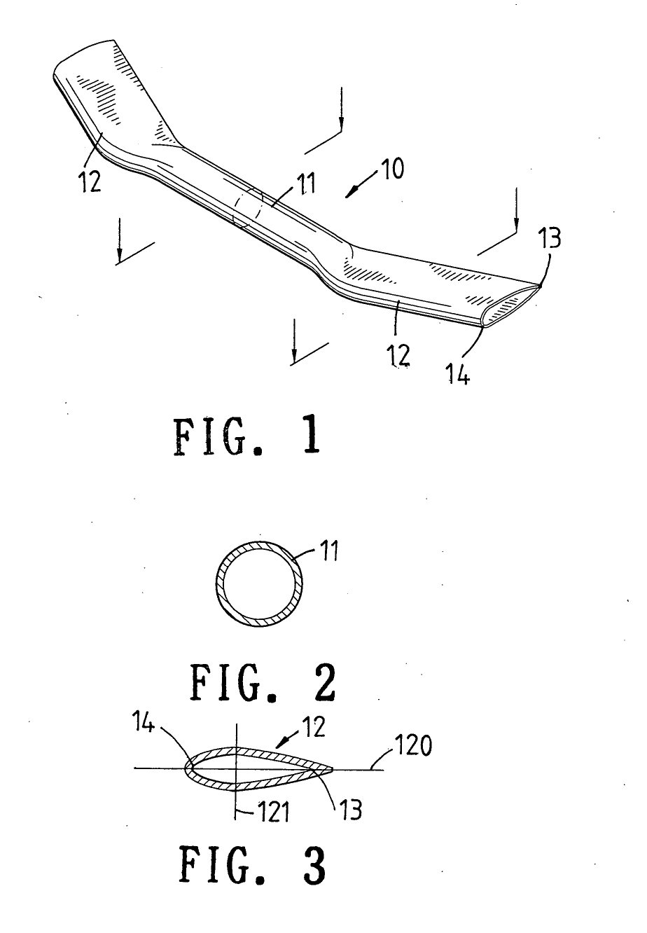

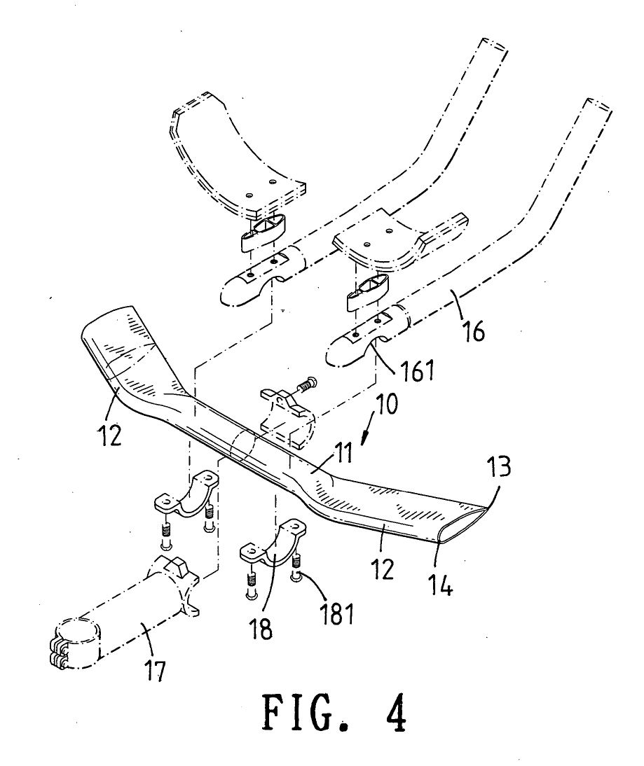

Referring to FIGS. 1, 4 and 5, the handlebar 10 of the present invention comprises a straight central fitting section 11 and two wings 12 are integrally connected to two ends of the central fitting section 11. The central fitting section 11 has a circular cross section as shown in FIG. 2 and each wing 12 has a tear-shaped cross section including a long axis and a short axis which orthogonally intersects the long axis at a intersection point as shown in FIG. 3. A distance from the intersection point to a front end 13 of each of the tear-shaped wings 12 is longer than a distance from the intersection point to a rear end 14 of each of the tear-shaped wings 12. In other words, the front section including the front end 13 is flatter than the rear section including the rear end 14, and the two low profile sides of the front section cut the air flow so that the air resistance is smaller than the conventional handlebar.

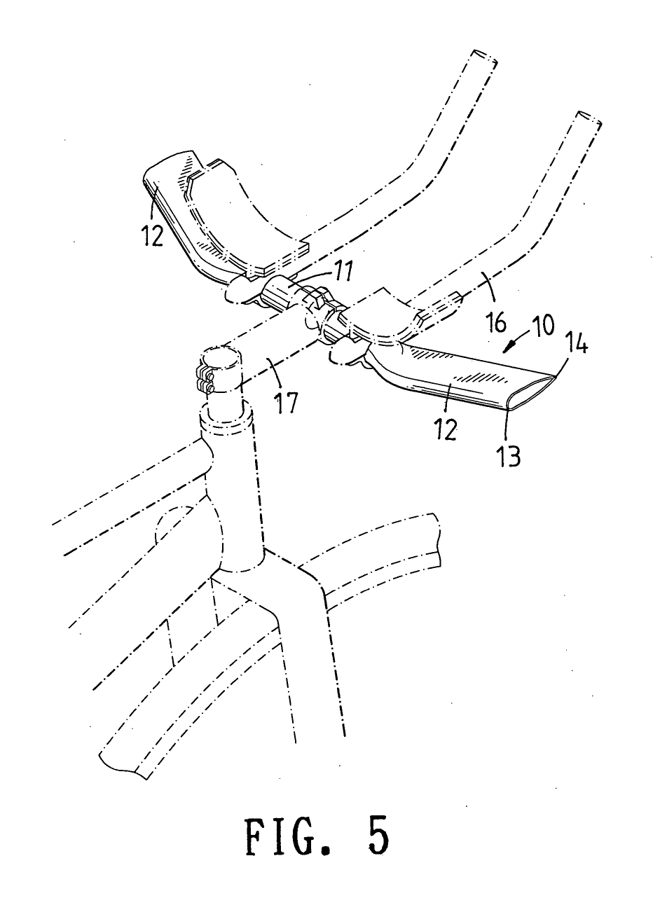

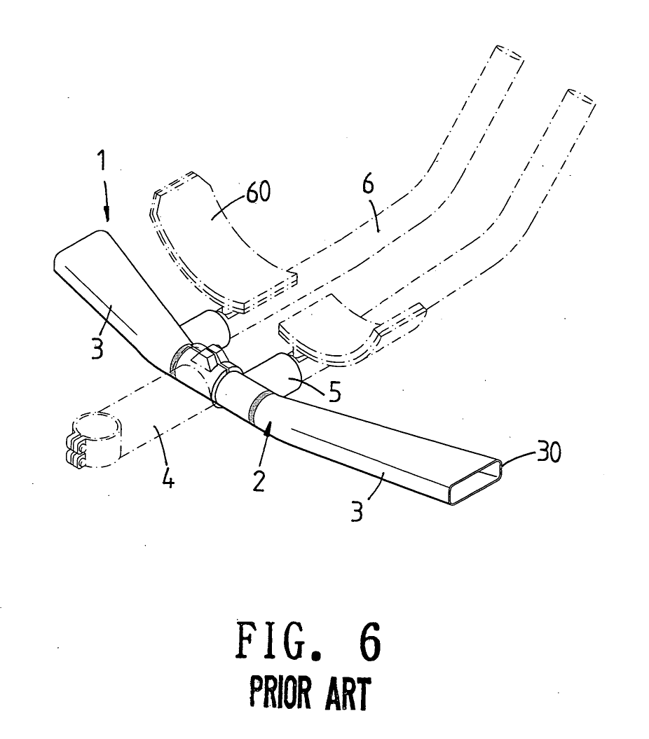

The handle 10 can be connected to an end of a handlebar stem 17 and the other end of the handlebar stem 17 is connected to a steerer tube extending through a head tube of a bicycle frame as shown in FIG. 5. Two armrests 16 each have a recess 161 defined in an outer periphery thereof and the central fitting section 11 is engaged with the recess 161 of each of the two armrests 16. Two C-shaped members 18 are mounted to the central fitting section 11 and two bolts 181 extend through two ends of each of the C-shaped members 18 and are connected to the two armrests 16. By the specific arrangement, the angle of the armrests 16 relative to the handlebar 10 can be adjusted by loosening the bolts 181 and rotating the armrests 16.

While we have shown and described the embodiment in accordance with the present invention, it should be clear to those skilled in the art that further embodiments may be made without departing from the scope of the present invention.

1. A bicycle handlebar comprising:
a central fitting section and two wings integrally connected to two ends of the central fitting section, each wing having a tear-shaped cross section including a long axis and a short axis which orthogonally intersects the long axis at a intersection point, a distance from the intersection point to a front end of each of the tear-shaped wings being longer than a distance from the intersection point to a rear end of each of the tear-shaped wings.

2. The handlebar as claimed in claim 1, wherein the central fitting section has a circular cross section.

3. The handlebar as claimed in claim 1 further comprising two armrests each having a recess defined in an outer periphery thereof and the central fitting section being engaged with the recess of each of the two armrests.

4. The handlebar assembly as claimed in claim 3 further comprising two C-shaped members which are mounted to the central fitting section and two bolts extending through two ends of each of the C-shaped members and connected to the two armrests.
